(19) United States
(12) Patent Application Publication
(10) Pub. No.: US 2022/0225743 A1
(43) Pub. Date: Jul. 21, 2022

(54) Configurable Storage Container and Compartments

(71) Applicant: Jeanne Sutton, Prairieville, LA (US)

(72) Inventor: Jeanne Sutton, Prairieville, LA (US)

(21) Appl. No.: 17/592,503

(22) Filed: Feb. 3, 2022

Related U.S. Application Data
(63) Continuation of application No. PCT/US2020/041086, filed on Jul. 7, 2020.
(60) Provisional application No. 62/882,986, filed on Aug. 5, 2019.

(51) Int. Cl. A45C 5/03

(52) U.S. Cl. CPC A45C 5/03; A45C 2013/026; A45C 2005/037

(57) ABSTRACT

An improved apparatus for storing articles in the form of a storage container having a grid system in its floor that mates with various-sized bins and attachments having a corresponding mating surface, and a lid with a series of uniquely positioned baffles to restrict the movement of the contents within.

### CONTINUATION HISTORY

This application is a continuation (or “bypass application”) of, and claims priority to, PCT Application PCT/US2020/041086, filed on 7 Jul. 2020, which is a continuation of, and claims priority to, U.S. Provisional Patent Application 62/882,986, filed on 5 Aug. 2019, both of which are hereby incorporated by reference in their entirety.

### BACKGROUND OF THE INVENTION

The present invention relates to a design for a storage container having configurable containers therein.

Storage containers are as useful as they are old. For ages, the ability to consolidate, carry and organize items has served a critical part of our day-to-day lives. From toolboxes to backpacks, storage containers are ubiquitous, and coupling storage with organization is a tremendous advantage.

While the concept of storage is very well known, oftentimes there are limitations in the utility as currently employed in the known art. Storage containers are frequently not the most durable items, sometimes a consequence of build quality, sometimes that of poor engineering. Many containers do not shield their contents sufficiently from the elements, or prevent the intrusion of dust and moisture. Organization is also often lacking in storage containers, since most approach storage needs with a “one size fits all” approach to storage.

The consequence of these issues is the inherent ineffectiveness of the current state of the art for storage containers. A solution which provides a simple way to effectively provide an adaptable, secure and sealed storage container has yet to be developed. All of the above aspects of the current state of storage containers lead to an increased need for a revised method of implementation with minimized cost and complexity, all of which the present invention addresses.

The disclosed invention provides a simple, innovative and effective apparatus for avoiding these problems. The proposed invention of a modular storage container is thus a novel, needed and functional answer to the problems in the field relating to storage containers and their use.

In the present invention, a storage container is built having the basic structure of a container with an integral lid, and wherein the container has a grid system formed into the inside floor of the storage container which couples to a corresponding mating system on user-selectable storage bins, paired with a unique lid-baffle system. This combination of features leads to independent, adaptable, customizable secure storage contained within an innovative container unlike any other available in the present state of the art.

### OBJECTS OF THE INVENTION

One object of the invention is to provide a new storage container design.

An additional object of this invention is to provide a new storage container design having a plurality of bins.

Another object of this invention is to provide a storage container that secures the contents of each storage bin apart from any other storage bin.

Yet another object of this invention is to provide a storage container which allows user-configurable sizes of storage bins to be placed within the storage container.

Still another object of this invention is to provide a storage container which allows user-configurable shapes of storage bins to be placed within the storage container.

Still another object of this invention is to provide a storage container which allows user-configurable orientations of storage bins to be placed within the storage container.

Still another object of this invention is to provide a storage container having baffles in the lid to keep separate the contents of each bin regardless of positioning of the storage container.

Other objects and advantages of this invention shall become apparent from the ensuing descriptions of the invention.

### SUMMARY OF THE INVENTION

An improved apparatus for storing articles in the form of a storage container having a grid system in its floor that mates with various-sized bins and attachments having a corresponding mating surface, and a lid with a series of uniquely positioned baffles to restrict the movement of the contents within.

### BRIEF DESCRIPTION OF THE DRAWINGS

The accompanying drawings and figures illustrate embodiment(s) of this invention. However, it is to be understood that these embodiments are intended to be neither exhaustive, nor limiting of the invention. They are but examples of some of the forms in which the invention may be practiced.

FIG. 1 is a front perspective view of the storage container.

FIG. 2 is a top view of the storage container.

FIG. 3 is a top view and internal view of the storage container.

FIG. 4 is a perspective view of the rear of the storage container.

FIG. 5 is a bottom view of the lid.

FIG. 6 is a perspective view of the bins.

FIG. 7 is a top, side and bottom view of the bins.

FIG. 8 is a bottom perspective view of the bins.

FIG. 9 is a cutaway view of the storage container with bins locked in place.

FIG. 10 is a perspective view of the storage mating system.

FIG. 11 is a close-up and cutaway view of the bins and attachment system.

FIG. 12 is a top view of the storage container with bins when bins are employed in a sectional approach when all sides are not configured to be fully enclosed.

### DETAILED DESCRIPTION OF EXEMPLARY EMBODIMENTS

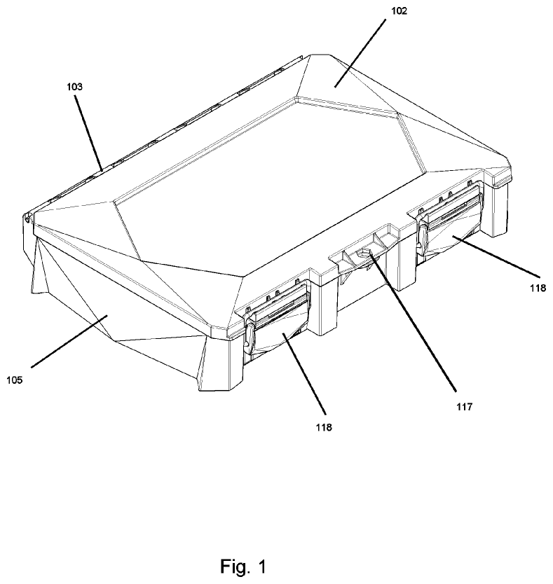

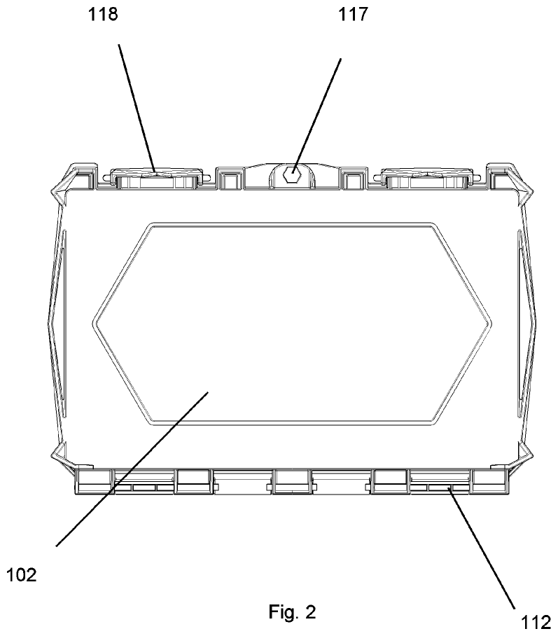

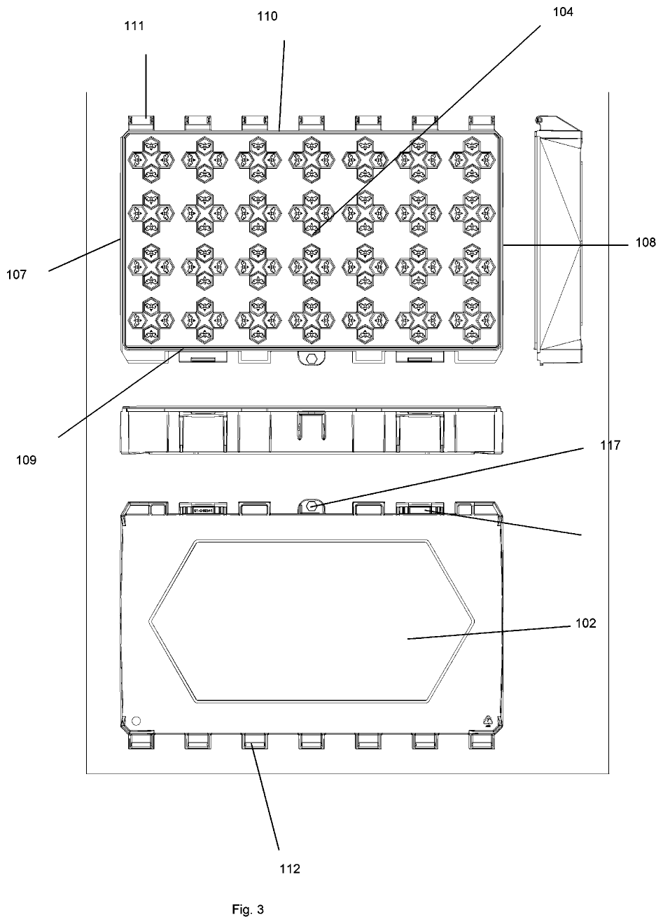

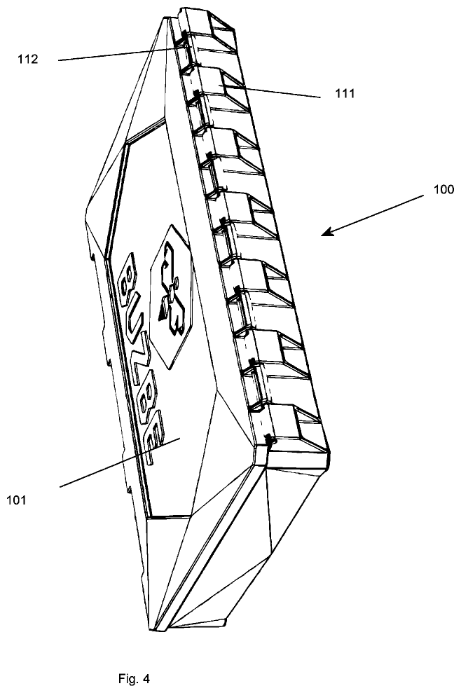

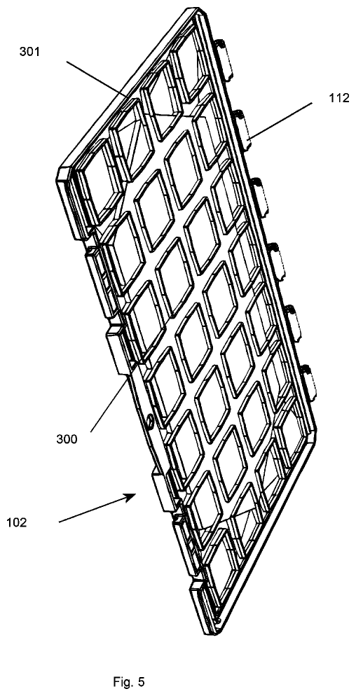

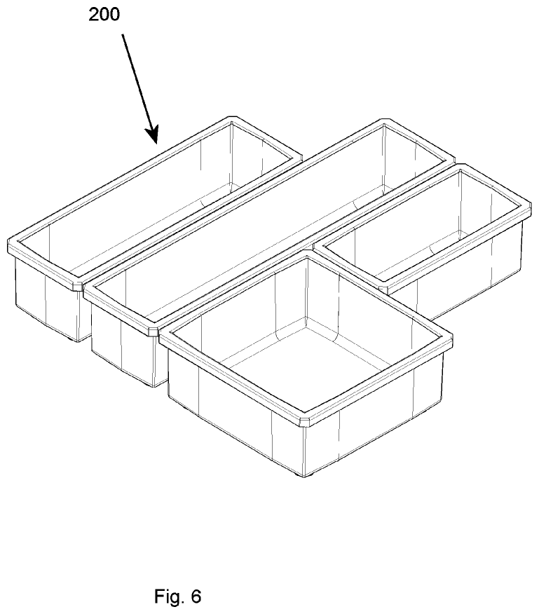

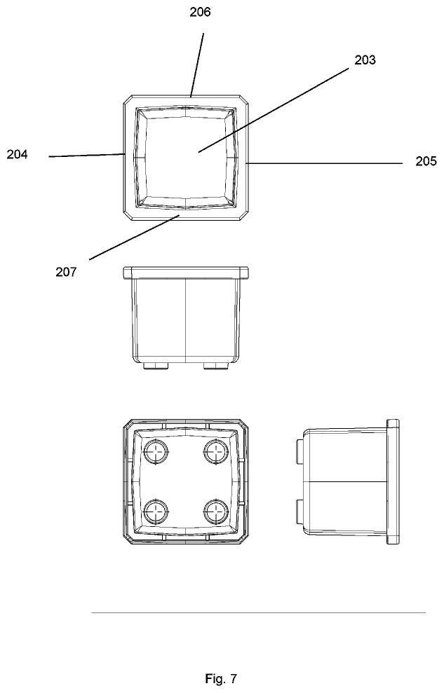

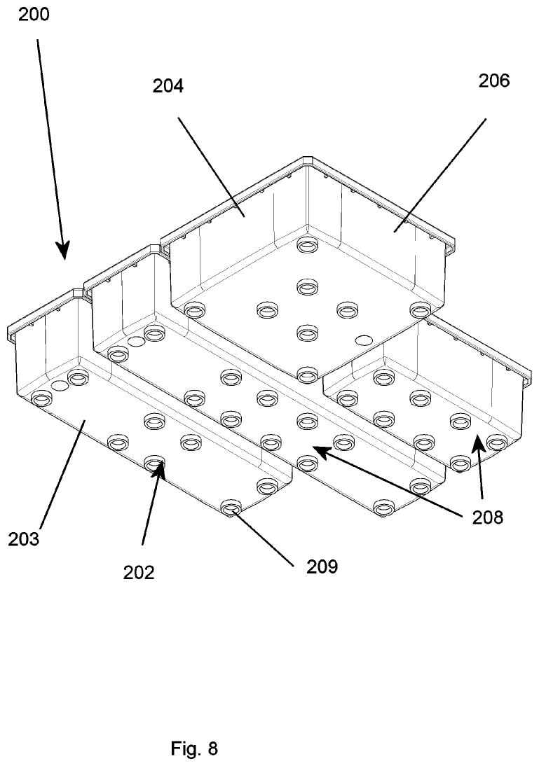

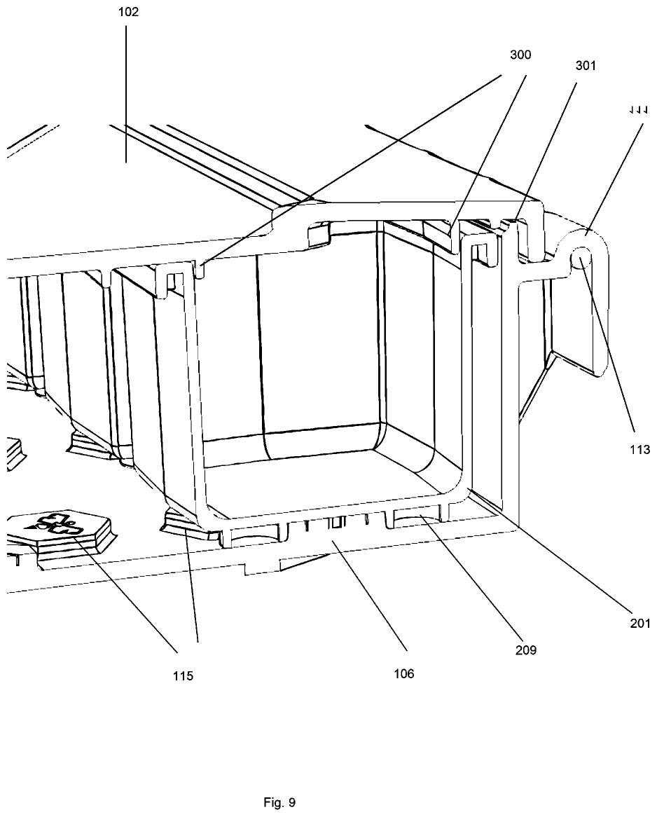

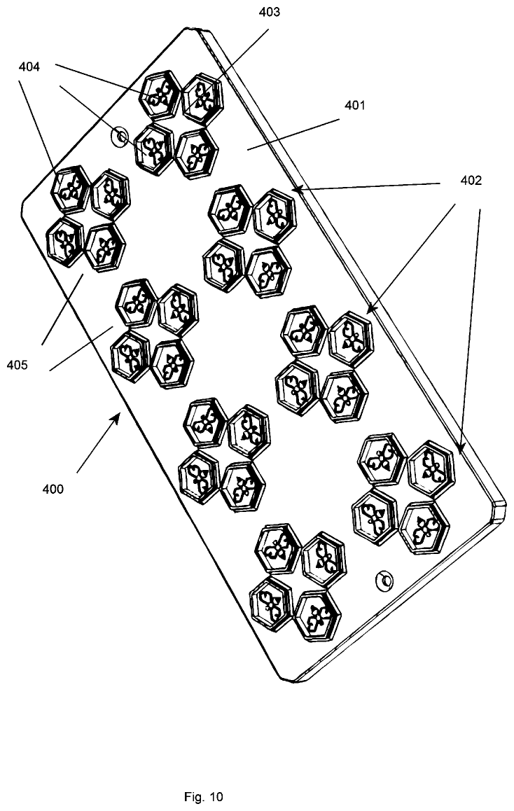

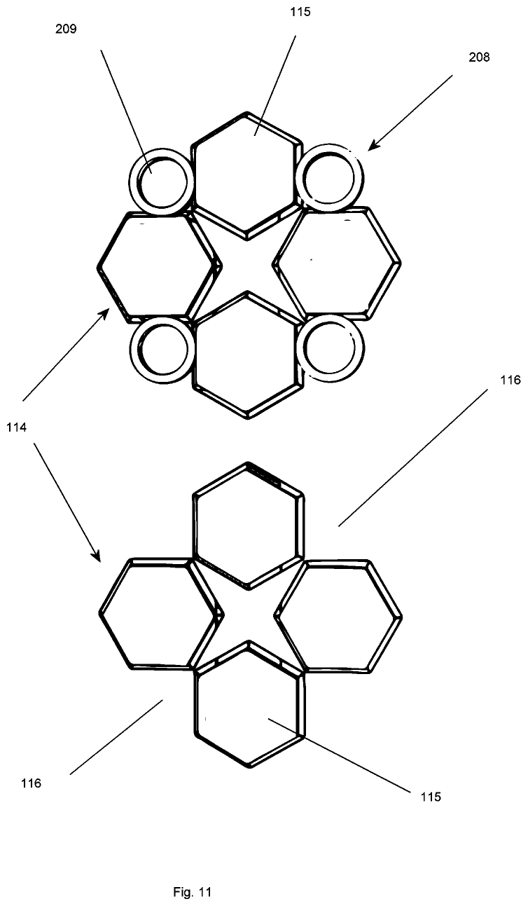

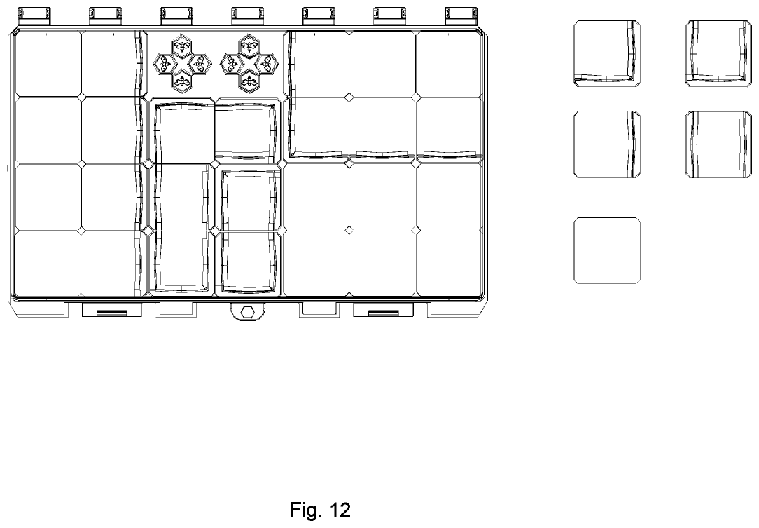

Without any intent to limit the scope of this invention, reference is made to the figures in describing the various embodiments of the invention. FIGS. 1 through 12 depict various aspects of exemplary embodiments of the present invention.

Provided is a novel apparatus for storage of items in an interlocking, modular, and customizable system.

An exemplary embodiment of the present invention includes a configurable storage container system 100 composed of four major components, namely vessel 101, lid 102, hinge system 103, and attachment interface 104.

Vessel 101 is a substantially cuboid-shaped vessel body 105 comprised of five sides, comprising floor 106, left side 107, right side 108, rear side 109 and front side 110. Each of these sides has at least four edges forming a substantially rectangular overall shape, with variations to the shape falling within the scope of this invention. In this preferred embodiment, left side 107, right side 108, rear side 109, and front side 110 are all operatively attached along one of each of their edges to one each of floor's 106 four edges, forming a substantially enclosed vessel 101.

Vessel 101 itself, in a preferred embodiment is composed of a strong, durable material, such as an ABS plastic. Additionally, in a preferred embodiment, the front and corners of vessel 101 will be double-walled, which bolsters the strength of not only the corners and front, but the entire structure of vessel 101. It also aids in absorbing kinetic energy in falls by absorbing impact in the first wall prior to delivery of a lesser impact event to the second wall. This double wall construction, together with a thickened side wall in a preferred embodiment, also eliminates the need for internal supports to provide the needed strength and torsional rigidity required to keep vessel's 101 structural integrity intact when opened. This elimination of internal supports, in turn, allows for maximum storage space within the storage container in the absence of structural members which would consume space therein.

Lid 102 is comprised of a substantially flat and substantially rectangular-shaped polygon having at least four edges and is configured to substantially engage and enclose vessel 101 when placed atop vessel 101 along what would be the sixth side of the cuboid shape.

Lid 102 can be of many different substantially rigid materials, but in a preferred embodiment, a polycarbonate material would be used to permit easy inspection of the contents of the storage container. Additionally, polycarbonate is exceptionally strong and impact resistant. Further, in a preferred embodiment, a UV resistant additive is provided to maintain the clarity of lid 102 and prevent “yellowing” or clouding of the polycarbonate material.

In an exemplary embodiment, lid 102 is affixed to vessel 101 via hinge system 103, which has three main components, namely vessel hinge points 111, lid hinge points 112, and hinge pin 113. A plurality of vessel hinge points 111 are located along one edge of said rear side while corresponding plurality of lid hinge points 112 along one edge of lid 102 and are joined by at least one hinge pin 113 configured to be inserted through vessel hinge points 111 and through lid hinge points 112 thus binding the two together in a hinged relationship.

Lid 102 will be attached to the vessel 101 along substantially one edge of both lid 102 and vessel 101, and in a preferred embodiment, on one of the longer edges of the cuboid shape. Having hinge system 103 run along substantially the entire edge aids in the longevity and strength of the overall structure when opened. The two components of vessel 101 and lid 102, would, in a preferred embodiment, mate, and be attached via a 316 stainless steel hinge pin 113. The use of this material prevents rust and corrosion, and is ideal in several situations, including the saltwater environment of many fishing locations. Since an ideal use of this storage container is fishing tackle due to the size, shape and quantity of items used, this attribute is of particular import.

Hinge system 103 can also, in an exemplary embodiment, include a stop in travel to prevent lid 102 from being opened beyond much more than 180-190 degrees, making it easier to use without tipping or flipping when opened fully.

Lid 102 would additionally include a sealing system to prevent intrusion of water, dust, or other elements when closed. Many variations of a seal may be employed, but a preferred embodiment would be an injectable and sufficiently flexible material that fills in channel 301 which follows the entire perimeter of lid 102, effectively creating a permanent barrier between the seal and lid 102. This injectable material avoids the issues of having a seal which can fall out or otherwise be compromised or easily lost or removed. The durometer of the seal material is also preferably optimized to create a water-tight seal, as well as enough return decompression to open the lid slightly to make opening the lid easier once latches 118 are opened due to the rebound of the seal material.

Lid 102 of the storage container may also be designed in a preferred embodiment with a unique baffle system which helps to keep the contents of the storage container confined within their respective bins. Due to the enormous number of different configurations possible, a typical baffle system cannot be employed as in other, fixed storage systems. Lid 102 of the present invention employs baffles 300 in a broken grid pattern, resembling a dashed line and when lid 102 is closed, extend perpendicularly into bins 200 of the storage container 100. This broken grid pattern allows baffle 300 to be present for the inner edge of each bin 200 without having to account for each possible configuration individually. Baffles 300 keep the contents of each bin 200 in the bin 200 and prevents the commingling of contents with neighboring bins 200.

Latch 118 is also employed in an exemplary embodiment, which selectively binds lid 102 to vessel body 105 in order to keep vessel 101 secure and the contents contained therein. In a preferred embodiment, the use of glass-filled nylon will increase durability. Latches 118 are further designed in a preferred embodiment to have a precise amount of deflecting pressure which allows them to pop up and away from the lid in one quick motion while opening. A simple pulling up motion on the latch from underneath will readily release the latch for easy one-handed operation.

Attachment interface 104 is integrated into the largest plane of the interior of vessel 101 (though it can be along any plane) but in the exemplary embodiment, attachment interface 104 is integrated into floor 106 within formed vessel 101 and includes a plurality of protrusion groups 114, each protrusion group 114 having a plurality of vessel protrusions 115 which are in a substantially perpendicular orientation to floor 106 and wherein vessel protrusions 115 are configured in a substantially cross-shaped pattern, which, in turn, form a plurality of locking channels 116 in each protrusion group 114.

Complementing this storage container system 100, vessel 101 can be utilized to contain and secure one or more detachable storage bins 200, such storage bins 200 being made of bin body 201 and bin attachment interface 202. Bins 200 can be of several sizes and shapes of cuboid-shaped bins having up to five substantially closed sides, and an open top, creating a storage receptacle or divider. Bins 200 also have a plurality of protrusions 209 extending substantially perpendicularly from the exterior floor 203 of bins 200 and are shaped to interlock with aforementioned protrusions 115 of storage container system 100 such that the frictional fitment between bin protrusions 209 and vessel protrusions 115 retains bins 200 to vessel 101.

Bin body 201 in this preferred embodiment, is substantially cuboid-shaped and has a plurality of sides, which include floor 203 and at least one of left side 204, right side 205, rear side 206 and front side 207. Each of these sides 203, 204, 205, 206 has at least four edges forming a substantially rectangular overall shape, and, each of sides 203, 204, 205, 206 are all operatively attached along one of each of sides' 203, 204, 205, 206 edges to one each of floor's 203 four edges, which form a substantially enclosed bin. By employing floor 203 and a limited number of sides 203, 204, 205, 206, a sectional approach can be made to essentially create custom-sized and -shaped bins 200 according to a user's exact specification, as seen in the FIGS.

Bins 200 may also employ solely floor 203 with no additional sides, such that the bin 200 only serves to cover the section of vessel 101 it engages, creating a flat section of floor 106.

Bins 200 may also be coated in a softer material to protect parts stored therein from impacts and abrasions.

Other items can be produced with the same protrusions 209 so that they can also interlock with vessel's 101 protrusions, such as a fishing line holder, slots, light, battery pack, brackets, hitchpoints, or any other item capable of being mounted within the storage container system 100. Colors and translucence/transparency of bins 200 can also be varied depending on the need of the user of the storage container, as well as an aid in the rapid identification of contents by a user.

Bin attachment interface 202 includes a plurality of bin protrusion groups 208 integrated into the exterior of floor 203 of detachable storage bin 200, each bin protrusion group 208 having a plurality of bin protrusions 209 in a substantially perpendicular orientation to floor 203 and wherein bin protrusions 209 are further configured in a pattern and number sufficient to frictionally engage vessel protrusions 115 of vessel 101 permitting the detachable affixation of detachable storage bin 200 to storage container system 100.

The shape of vessel protrusions 115 are, in the FIGS., polygon shaped, particularly hexagonal, while bin protrusions 209 are circular. These shapes may be reversed with similar operational function, (i.e., circular on vessel 101 side and polygons on the bin 200 side) or substituted for varying shapes and polygons as desired. In an ideal embodiment and the exemplary embodiment presented herein, the vessel protrusions 115 are four hexagons in a “north, south, east, west” pattern to allow for bin protrusions 209 (in a preferred embodiment, these may be in a circular shape) on the bottom of bins 200 to attach and give an accurate placement and connectivity in both a vertical and horizontal manner.

The vessel protrusions 115 are arranged in such a manner to accept the matching bin protrusions 209, and are repeated in a grid-style pattern to allow a multitude of configurations to be achieved. Due to this grid interlocking system, bins 200 can be placed in various places within vessel 101, creating unique storage spaces. Bins 200 may also be varied in size and shape to create customizable bin storage, and overall storage container configurations. Bins 200 can be substantially square, for example, or rectangular, or any other shape, if desired. The sizes can similar range from small to large depending on the need, an example of which can be seen in the FIGS. They may also be arranged in any order desired. These attributes are driven by the grid-style arrangement of protrusions 115 within the storage container vessel 101, which can interlock with the bins' 200 protrusions 209 in multiple ways. For example, bin 200 may be easily placed horizontally or vertically, depending on the application, and can be placed anywhere about the protrusion 115 grid.

It should be noted that this unique grid system of protrusions 115 also only permits bins 200 and/or attachments to be placed in a certain, predefined manner, thus preventing errant attachments that may prevent the maximum use of space. This grid system and attachment point arrangement effectively “snaps” the bins to the proper grid alignment, rather than allowing attachment between grid sections. This is also critical in the employment of baffles 300 which require bins 200 to be placed in a fashion that enables baffles 300 to properly engage bin body 201.

Lid 102, in a preferred embodiment would also include an additional feature to help retain the contents of bins 200 both within vessel 101 and within each bin body 201, to prevent the contents from shifting between bins 200. This is accomplished by having baffles 300 on the inside of lid 102.

Lid 102 can also, in a preferred embodiment, have channel 301 that a seal can be injected into to aid in weatherproofing system 100.

A two-part hasp 117 can also be employed in storage container system 100 by way of a hasp, or hasps located in vessel 101 and a corresponding hasp in lid 102.

Storage container 100 would also, in a preferred embodiment, have a plurality of “feet” along the perimeter edge, or in the corners, of the bottom of storage container 100, together with a polygon rib, creating an ideal mating surface for containers to be stacked, as these bottom features match a corresponding, but mirror imaged, receptacles and polygon groove on the lid of storage container 100.

In an alternate embodiment, configurable standalone storage mating system 400 is presented, such as a independent planar mating surface 401 and attachment interface 402 and wherein mating surface 401 is comprised of a substantially flat polygon having at least three edges and wherein attachment interface 402 has a plurality of protrusion groups 403 integrated into mating surface 401, each protrusion group 403 comprising a plurality of mating surface protrusions 404 in a substantially perpendicular orientation to mating surface 401 and wherein mating surface protrusions 404 are configured in a substantially cross-shaped pattern, forming a plurality of locking channels 405. Storage mating system 400 could then be attached to multiple surfaces both vertical (such as walls) and horizontal (such as tables). Further, this system 400 may be attached where the surface faces a downward position toward the ground such as the bottom surface of a table. Fastening of this system 400 can be accomplished in a myriad ways, including, but not limited to, screws, nails adhesives, and hook and loop fasteners.

This system is also designed such that multiple mating surfaces 401 of this type of surface can be positioned adjacent to one another and will continue the pattern of protrusions with the correct spacing to allow continued connectivity in any desired size up to a theoretically infinite size. This modular sizing could thus be used in larger scale applications for things such as AC duct work, cabinets, shelving, mounting brackets, wiring harnesses, wall art, garage organization, trade show booths and the like.

Storage mating system 400 can then be used with the same storage bins 200 as outlined above, or any other attachments similarly equipped with corresponding protrusions 209.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined herein.

The invention claimed is:

1. A configurable storage container system comprising a vessel, a lid, a hinge system, and an attachment interface, wherein:
a. said vessel is comprised of:
i. a substantially cuboid-shaped vessel body comprised of five sides, comprising a floor, a left side, a right side, a rear side and a front side;
1. wherein each of said five sides has at least four edges forming a substantially rectangular overall shape; and
2. wherein said left side, said right side, said rear side, and said front side are all operatively attached along one of each said left, right, rear and front side's said edges to one each of said floor's four edges, forming a substantially enclosed vessel;
b. said lid is comprised of a substantially flat and substantially rectangular-shaped polygon having at least four edges and configured to substantially engage and enclose said vessel when placed atop said vessel;
c. said hinge system comprised of:
i. a plurality of vessel hinge points along one edge of said rear side;
ii. a corresponding plurality of lid hinge points along one edge of said lid; and
iii. at least one hinge pin configured to be inserted through said plurality of vessel hinge points and through said plurality of lid hinge points thus binding the two together in a hinged relationship;
d. said attachment interface is integrated into said floor within said formed vessel and comprised of a plurality of protrusion groups, each protrusion group comprising a plurality of vessel protrusions in a substantially perpendicular orientation to said floor and wherein said vessel protrusions are configured in a substantially cross-shaped pattern, forming a plurality of locking channels in each said protrusion group.

2. The configurable storage container system of claim 1 further comprising at least one detachable storage bin, said storage bin comprising a bin body and a bin attachment interface, wherein:
a. said bin body is substantially cuboid-shaped and comprised of a plurality of sides, comprising a floor and at least one of a left side, a right side, a rear side and a front side and wherein;
i. each of said at least one sides has at least four edges forming a substantially rectangular overall shape; and
ii. each of said at least one sides are all operatively attached along one of each of said at least one sides' said edges to one each of said floor's four edges, forming a substantially enclosed bin;
b. said bin attachment interface comprising a plurality of bin protrusion groups integrated into said floor on the exterior of said detachable storage bin, each bin protrusion group comprising a plurality of bin protrusions in a substantially perpendicular orientation to said floor and wherein said bin protrusions are further configured in a pattern and number sufficient to frictionally engage said vessel protrusions of said vessel permitting the detachable affixation of said detachable storage bin to said storage container system.

3. The configurable storage container system of claim 1 wherein said vessel protrusions are polygon-shaped.

4. The configurable storage container system of claim 2 wherein said bin protrusions are substantially circular in shape.

5. The configurable storage container system of claim 1 wherein said vessel protrusions are substantially circular in shape.

6. The configurable storage container system of claim 2 wherein said bin protrusions are polygon-shaped.

7. The configurable storage container system of claim 2 wherein said lid further comprises a plurality of polygon-shaped baffles formed perpendicularly to said lid and configured to engage the open sides of each and every said at least one storage bin when said at least one storage bin is interlocked within said vessel, substantially enclosing the top side of said at least one storage bin.

8. The configurable storage container system of claim 1 further comprising a channel formed along the inner perimeter of said lid, wherein said channel is filled with a sealing material with a durometer of sufficient quantity to allow the lid to sufficiently engage said vessel in order to prevent water and dust intrusion.

9. The configurable storage container system of claim 1 further comprising at least one vessel hasp on said one edge of at least one of said left side, right side, rear side or front side, and further comprising at least one corresponding lid hasp on said one edge of said lid, such that a locking device can be placed through said at least one vessel hasp and said at least one lid hasp to prevent the opening of said storage container system.

10. The configurable storage container system of claim 1 wherein at least one of said left side, said right side, said rear side, and said front side are all double-walled.

11. A configurable storage mating system comprising a mating surface and an attachment interface and wherein:
a. said mating surface is comprised of a substantially flat polygon having at least three edges; and
b. said attachment interface is comprised of a plurality of protrusion groups integrated into said mating surface, each protrusion group comprising a plurality of mating surface protrusions in a substantially perpendicular orientation to said mating surface and wherein said mating surface protrusions are configured in a substantially cross-shaped pattern, forming a plurality of locking channels.

12. The configurable storage mating system of claim 11 further comprising at least one detachable storage bin, said storage bin comprising a bin body and a bin attachment interface, wherein:
a. said bin body is substantially cuboid-shaped and comprised of a plurality of sides, comprising a floor and at least one of a left side, a right side, a rear side and a front side and wherein;
i. each of said at least one sides has at least four edges forming a substantially rectangular overall shape; and
ii. each of said at least one sides are all operatively attached along one of each of said at least one sides' said edges to one each of said floor's four edges, forming a substantially enclosed bin;
b. said bin attachment interface comprising a plurality of bin protrusion groups integrated into said floor on the exterior of said detachable storage bin, each bin protrusion group comprising a plurality of bin protrusions in a substantially perpendicular orientation to said floor and wherein said bin protrusions are further configured in a pattern and number sufficient to frictionally engage said mating surface protrusions of said mating surface permitting the detachable affixation of said detachable storage bin to said storage mating system.

13. The configurable storage container system of claim 11 wherein said mating surface protrusions are polygon-shaped.

14. The configurable storage container system of claim 12 wherein said bin protrusions are substantially circular in shape.

15. The configurable storage container system of claim 11 wherein said mating surface protrusions are substantially circular in shape.

16. The configurable storage container system of claim 12 wherein said bin protrusions are polygon shaped.

17. The configurable storage container system of claim 1 further comprising at least one detachable storage bin, said storage bin comprising a bin body and a bin attachment interface, wherein:
a. said bin body comprises a floor;
b. said bin attachment interface comprising a plurality of bin protrusion groups integrated into said floor on the exterior of said detachable storage bin, each bin protrusion group comprising a plurality of bin protrusions in a substantially perpendicular orientation to said floor and wherein said bin protrusions are further configured in a pattern and number sufficient to frictionally engage said vessel protrusions of said vessel permitting the detachable affixation of said detachable storage bin to said storage container system.

18. The configurable storage container system of claim 1 wherein hinge includes a hinge stop operatively configured to limit travel of said lid when opened.
